(19) United States
(12) Patent Application Publication
(10) Pub. No.: US 2024/0304924 A1
(43) Pub. Date: Sep. 12, 2024

(54) Battery Pack for a Traction Battery of a Motor Vehicle, and Traction Battery for a Motor Vehicle

(71) Applicant: Bayerische Motoren Werke Aktiengesellschaft, Muenchen (DE)

(72) Inventors: Emanuel PREIS, Muenchen (DE); Julia SAJKO, Muenchen (DE); Florian SOLDNER, Brannenburg (DE)

(21) Appl. No.: 18/598,839

(22) Filed: Mar. 7, 2024

(30) Foreign Application Priority Data
Mar. 8, 2023 (DE) 10 2023 105 680.8

(51) Int. Cl. H01M 50/242; H01M 50/213; H01M 50/249; H01M 50/293

(52) U.S. Cl. CPC H01M 50/242; H01M 50/213; H01M 50/293; H01M 50/249; H01M 2220/20

(57) ABSTRACT

A battery pack for a traction battery of a motor vehicle. The battery pack has a multiplicity of battery embedded in a foam body having regions of different stiffnesses. The foam body has a main body made of a structural foam of a first stiffness and a deformation foam with a second stiffness lower than the first stiffness. The deformation foam, on a side of the battery pack on which outermost battery cells are offset outwardly or inwardly relative to one another, outwardly covers respective outwardly offset battery cells on a shortest straight line from a center axis of the respective battery cells toward the side of the battery pack. The deformation foam is arranged without coverage in relation to respective shortest straight lines from a center axis of the respective inwardly offset battery cells toward the side of the battery pack.

### CROSS REFERENCE TO RELATED APPLICATION

This application claims priority under 35 U.S.C. § 119 from German Patent Application No. 10 2023 105 680.8, filed Mar. 8, 2023, the entire disclosure of which is herein expressly incorporated by reference.

### BACKGROUND AND SUMMARY

The invention relates to a battery pack for a traction battery of a motor vehicle and to a traction battery for a motor vehicle.

EP 2 418 709 B1 discloses a battery pack comprising a multiplicity of battery elements, which are packed next to one another in at least one packing layer, with at least one deformation element being arranged between at least two adjacent battery elements at least in certain regions within a packing layer. Under an external action of force, the battery elements can be displaced with deformation of deformation elements. The battery elements are formed from a multiplicity of battery cells and the at least one deformation element is in the form of a foamed body. An interspace between the individual battery cells of a battery element can be filled with an auxiliary material, which can be a structural foam.

DE 10 2012 008 633 B4 also discloses a battery module for an electric motor car having a plurality of battery cells and at least one deformation element. The battery cells and the deformation element are arranged together inside a housing of the battery module. The deformation element is in the form of an extruded profile and is designed to absorb, by virtue of plastic deformation of its shape, mechanical energy that acts on the battery module from the outside. The battery cells are at least partially embedded in a structural foam and have a spacing from one another owing to the structural foam, the stiffness of the structural foam being at least twice that of the deformation element.

An object of the present invention is to provide a solution which enables particularly good protection against damage of battery cells embedded in a structural foam.

This object is achieved according to the invention by the subjects of the independent claims. Further possible embodiments of the invention are disclosed in the dependent claims, the description and the figures. Features, advantages and possible embodiments presented in the course of the description for one of the subjects of the independent claims should at least analogously be considered to be features, advantages and possible embodiments of the respective subjects of the other independent claims and each possible combination of the subjects of the independent claims, possibly in connection with one or more of the dependent claims.

The invention relates to a battery pack for a traction battery of a motor vehicle. The traction battery is designed to provide electrical energy for an electric drivetrain of the motor vehicle. The motor vehicle can thus be driven by the electric drivetrain using the electrical energy provided by the traction battery. The battery pack comprises a multiplicity of battery cells, which are embedded in a foam body having regions of different stiffnesses. The battery pack can be accommodated in a battery housing to produce the traction battery. The traction battery is in particular a high-voltage store for the motor vehicle. Embedding the battery cells in the foam body allows the foam body to be able to convert forces acting on the battery pack into deformation energy, as a result of which at least some of the forces acting on the battery pack can be absorbed. Owing to the provision of the regions of different stiffnesses of the foam body, forces acting on the battery pack can be selectively distributed among selected battery cells of the battery pack, as a result of which in particular forces acting on individual battery cells can be homogenized. This makes it possible to avoid individual battery cells of the battery pack being subjected to a particularly high load by the force acting on the battery pack, which could in turn result in damage to the correspondingly loaded battery cell. This high loading of the at least one battery cell could in turn lead to thermal runaway of this battery cell. Using the different stiffnesses of the foam to homogenize forces acting on the battery pack thus makes it possible to be able to protect the battery cells of the battery pack against thermal runaway particularly well.

In the case of the battery pack, it is provided that the foam body comprises a main body made of a structural foam of a first stiffness and a deformation foam with a second stiffness lower than the first stiffness. In this case, the foam body can comprise the deformation foam in particular in multiple regions that have a spacing from one another. In particular, the respective deformation regions that are made from the deformation foam are embedded in the structural foam of the foam body. The deformation regions can thus be surrounded by the structural foam at least to some of their respective sides. In the case of the battery pack, it is also provided that the deformation foam, on a side of the battery pack on which outermost battery cells are offset outwardly or inwardly relative to one another, outwardly covers respective outwardly offset battery cells on a shortest straight line from a center axis of the respective battery cell toward the side of the battery pack. In particular, for each outwardly offset battery cell, there is provided a deformation region which outwardly covers the outwardly offset battery cell on the shortest straight line from its center axis toward the side of the battery pack. The respective deformation regions, in which the foam body is made from the deformation foam, can thus protect respective outwardly offset battery cells against damage. The shortest straight line from the center axis of the respective battery cell toward the side of the battery pack corresponds to the spacing of the center axis of the respective battery cell from this side of the battery pack. The spacing, also the range or the distance between two points, is the length of the shortest connection between these points. The spacing is in particular the length of the straight section between these two points.

The deformation foam is also arranged without coverage in relation to the respective shortest straight line from a center axis of the respective inwardly offset battery cells toward the side of the battery pack. This means that the center axes of the respective inwardly offset battery cells are outwardly not covered by respective deformation regions on the side of the battery pack. In particular, the center axes of the respective inwardly offset battery cells are outwardly only covered by the structural foam of the foam body on the side of the battery pack. If, therefore, a force acts on the battery pack on the side of the battery pack, the force is absorbed less strongly by the structural foam covering the center axes of the inwardly offset battery cells than by the deformation foam covering the center axes of the outwardly offset battery cells, as a result of which the force acting on the battery pack is distributed particularly evenly among the battery cells arranged on this side of the battery pack irrespective of whether the battery cells are offset inwardly or outwardly. This makes it possible to avoid excessive loading of the battery cells offset outwardly on the side and consequently a risk of damage to these outwardly offset battery cells in the event of an action of force on the side of the battery pack can be kept particularly low.

One possible development of the invention provides that the deformation foam has different stiffnesses, which are selected on the basis of a structure of the outwardly offset battery cells, over its height extending parallel to a course of the respective center axes of the battery cells. In other words, the respective deformation regions of the foam body have different stiffnesses at different heights. The stiffness of the deformation region of the foam body at the respective different heights is selected on the basis of a configuration of the respective battery cell to be protected by the deformation region. Selecting the respective stiffness for the different heights of the deformation region thus makes it possible to convert the deformation region particularly well to a respective protection requirement for the battery cells over their height. A different damage-protection requirement for the battery cells over their height can result in particular owing to an arrangement of respective components of the battery cell in different regions over its height. In particular, the deformation region can be selected with a particularly low stiffness, in particular with a lower stiffness, at a height of particularly sensitive components of the battery cell than at a different height. This can have the effect that, in the event of an action of force on the battery pack, the acting force acts on the particularly sensitive components of the battery cell to a particularly small extent and at least some of the force is instead diverted to a more stable component of the battery cell. It is therefore possible to achieve particularly good protection of sensitive components of the battery cells.

Another possible embodiment of the invention provides that the structural foam has different stiffnesses, which are selected on the basis of a structure of the battery cell, over its height extending parallel to a course of the respective center axes of the battery cells. In particular, the structural foam can be formed with different stiffnesses at different vertical positions in respective stabilization regions, in which the structural foam outwardly covers the center axes of the respective inwardly offset battery cells on the side of the battery pack. In particular, the stiffnesses of the structural foam in the respective stabilization regions at the respective different heights can be selected on the basis of the protection requirement for the respective battery cells that are inwardly offset on the side of the battery pack. Selecting the respective stiffnesses of the structural foam in the stabilization regions for the different heights makes it possible to at least partially divert the force acting on the side of the battery pack to more stable components of the battery cells by setting the respective stiffness, in order to protect the more sensitive components of the battery cells. Adapting the stiffness of the stabilization regions or of the deformation regions over their respective height on the basis of the structure of the respective battery cells to be protected makes it possible to keep a risk of thermal runaway of the respective battery cell to be protected particularly low.

Another possible embodiment of the invention provides that the battery cells are in the form of round cells and their respective cross sections form a single hexagonal packing of circles in the battery pack. In other words, the respective cross sections of all the battery cells of the battery pack together form the hexagonal packing of circles. Owing to the respective battery cells being in the form of round cells, the battery cells have an at least substantially circular cross section. The hexagonal packing of circles of the respective battery cells enables a particularly dense packing of the respective battery cells. The battery pack can thus be provided in a particularly compact form with a particularly great power density. In particular in the case of the arrangement of the round cells in the hexagonal packing of circles, respective outermost battery cells are offset outwardly and inwardly in relation to one another at least on one side of the packing of circles. For example, each second outermost battery cell is outwardly offset and each second outermost battery cell is inwardly offset on this side of the battery pack, as a result of which the battery cells are alternately outwardly and inwardly offset along the side. Omitting the deformation foam in the foam body could have the effect that, in the event of an action of force on this side of the battery pack, outwardly offset battery cells at least partially absorb the force acting on the battery pack, as a result of which in turn a risk of damage to these battery cells is particularly high. The described embodiment of the battery pack with the deformation foam enables particularly good protection of these outwardly offset battery cells against damage caused by an action of force.

Another possible embodiment of the invention provides that all the battery cells are completely surrounded by the structural foam. This means that the battery cells of the battery pack are surrounded around the circumference by the structural foam with the first stiffness. A respective top side and bottom side of the battery cells can be outwardly covered by the structural foam, with the result that the battery cells are completely enclosed by the structural foam. As an alternative, it is possible for the top side and/or the bottom side of the respective battery cells to not be covered by the structural foam, as a result of which the battery cells can be accessed particularly well. The deformation foam with the second stiffness lower than the first stiffness can be arranged in the edge region of the foam body. Here, at least one deformation region may be embedded in the structural foam. This deformation region may be completely enclosed around the circumference by the structural foam. As an alternative, it is possible for the deformation region to not be covered by the structural foam at least on the first side and thus to the outside. Completely surrounding all the battery cells by means of the structural foam allows the structural foam to stabilize the battery cells of the battery pack particularly well. Furthermore, the battery cells can be connected to one another by the structural foam to form a battery block. A risk of individual battery cells becoming detached from the battery pack can be kept particularly low as a result.

Another possible embodiment of the invention provides that the deformation foam is a polyurethane foam. Polyurethane foams offer a very broad range of uses depending on the production method. In order to obtain this versatile foam, polyol and isocyanate are foamed using carbonic acid, it being possible to produce the foam with different consistencies. Producing the deformation foam from the polyurethane foam thus makes it possible to set the stiffness of the deformation foam particularly easily and precisely.

Another possible embodiment of the invention provides that all the battery cells are outwardly covered by a foam insert on the side of the battery pack, the foam insert comprising the deformation foam for the respective outwardly offset battery cells and respective stabilization regions between adjoining deformation foam for the inwardly offset battery cells, the stabilization regions having a higher stiffness than the second stiffness of the deformation foam. In other words, the battery cells of the battery pack can be surrounded, in particular encapsulated, by the structural foam and the foam insert can be placed against the side of the battery pack. The foam insert and the structural foam surrounding the battery cells together form the foam body. It is thus provided that the foam insert is placed against the side of the battery block formed from the battery cells encapsulated by the structural foam. The respective inwardly offset battery cells are outwardly covered by a respective stabilization region on a shortest straight line from a center axis of the respective battery cells on the side of the battery pack. Since the respective stabilization regions have a higher stiffness than the deformation regions made from the deformation foam, the foam insert causes the force acting on the side of the battery pack to be distributed evenly among the outwardly offset battery cells and the inwardly offset battery cells. This makes it possible to keep a risk of an overload of individual battery cells and consequently damage to these individual battery cells particularly low. Placing the foam insert against the battery block makes it possible to arrange the deformation foam on the side of the battery pack particularly easily. As an alternative to the lateral placement of the foam insert against the battery block, the respective deformation regions made from the deformation foam can be positioned laterally next to the battery cells and encapsulated by the structural foam together with the battery cells.

Another possible embodiment of the invention provides that the stabilization regions are made from the structural foam. This makes it possible for the foam body to consist of a particularly low number of different materials and consequently to be able to be recycled particularly easily.

The invention furthermore relates to a traction battery for a motor vehicle, comprising at least one battery pack as has already been described in conjunction with the battery pack according to the invention for a traction battery of a motor vehicle. The traction battery may in particular have a battery housing, in which the at least one battery pack is arranged. The use of the at least one battery pack in the traction battery makes it possible to keep a risk of damage to individual battery cells of the traction battery in the event of a lateral action of force on the traction battery particularly low.

Another possible embodiment of the invention provides that a housing attachment of the battery pack is inwardly covered by the deformation foam. This means that, in the event of an action of force on the housing attachment, the housing attachment can be moved toward the deformation foam or into the deformation foam particularly easily owing to the lower stiffness of the deformation foam compared with the structural foam, as a result of which force introduced into the battery pack via the housing attachment can be absorbed particularly well by deformation of the deformation foam. Consequently, the deformation foam can protect the battery cells of the battery pack particularly well against damage owing to an introduction of force via the housing attachment in the event of an action of force on the housing attachment.

Further features of the invention can emerge from the claims, the figures and the description of the figures. The features and combinations of features mentioned above in the description and the features and combinations of features presented below in the description of the figures and/or in the figures alone can be used not just in the respective specified combination but also in other combinations or individually, without departing from the scope of the invention.

In the drawing:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic plan view of a battery pack with multiple battery cells, which are embedded in a foam body;

FIG. 2 shows a schematic sectional view along the line A:A from FIG. 1;

FIG. 3 shows a schematic sectional view along the line B:B from FIG. 1; and

FIG. 4 shows a schematic diagram of a detail of the battery pack.

In the figures, elements that are the same or have the same function are provided with the same reference signs.

### DETAILED DESCRIPTION OF THE DRAWINGS

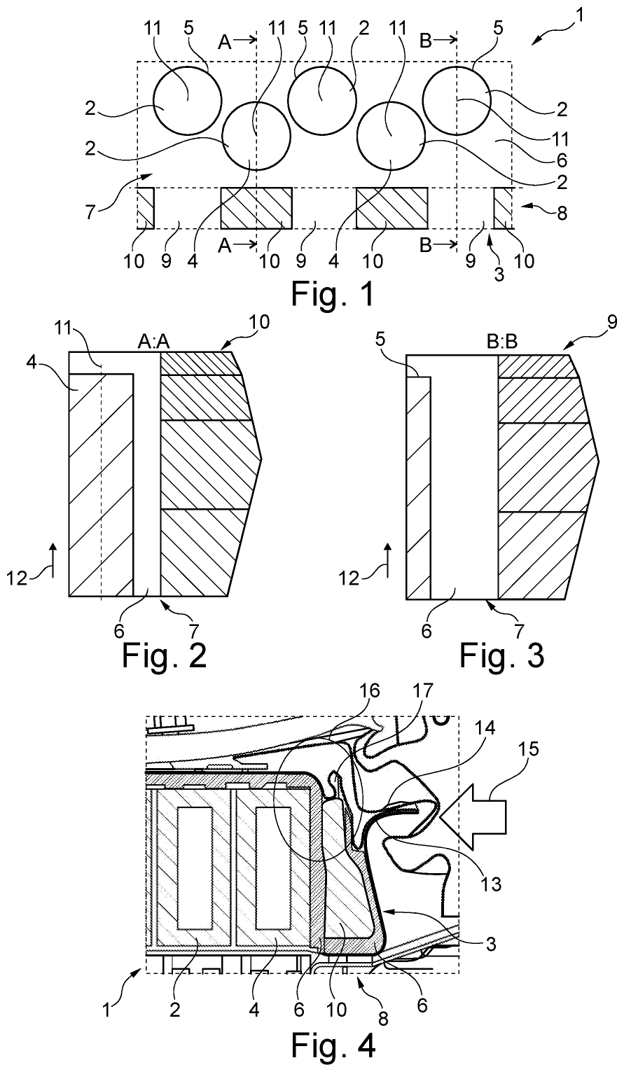

FIG. 1 illustrates a schematic plan view of a detail of a battery pack 1 for a traction battery of a motor vehicle. The battery pack 1 comprises a multiplicity of battery cells 2, which in the present case are in the form of round cells and are embedded in a foam body, which has different stiffnesses. The different stiffnesses of the foam body can be implemented by respectively associated different hardnesses. The round cells are arranged in the battery pack 1 with their respective cross sections forming a hexagonal packing of circles. Owing to the hexagonal packing of circles of the respective cross sections of the battery cells 2, respective outermost battery cells 2 are inwardly or outwardly offset on a given side 3 of the battery pack 1. This means that the outermost battery cells 2 facing the respective side 3, shown in FIG. 1, of the battery pack 1 are alternately inwardly and outwardly offset. In the following text, reference sign 4 is assigned to the respective outwardly offset battery cells 2. In the following text, reference sign 5 is assigned to the respective inwardly offset outermost battery cells 2.

As can be seen particularly well in FIG. 1, the inwardly offset battery cells 5 have a greater spacing from the side 3 of the battery pack 1 than the outwardly offset battery cells 4. In the event of a force acting on the side 3 of the battery pack 1, if the stiffness of the foam body is homogenous the force would firstly lead to deformation of the outwardly offset battery cells 4 and, depending on the penetration depth, would later lead to deformation of the inwardly offset battery cells 5. The battery pack 1 is designed such that the force acting on the side 3 of the battery pack 1 is distributed along the outwardly offset battery cells 4 and the inwardly offset battery cells 5 more evenly, in order to counteract excessive loading of the outwardly offset battery cells 4 and consequently damage to the outwardly offset battery cells 4.

In the present case, the battery cells 2 in the battery pack 1 are surrounded by a structural foam 6. The structural foam 6 connects the battery cells 2 of the battery pack 1 to form a battery block 7. A foam insert 8 is placed laterally against the battery block 7. The foam insert 8 outwardly covers all the battery cells 2 of the battery pack 1 on the side 3. In the present case, the foam insert 8 alternately has multiple stabilization regions 9 and deformation regions 10. The deformation regions 10 are made from a deformation foam. In the present case, this deformation foam is a polyurethane foam. In the present case, the stabilization regions 9 are made from the structural foam 6. In the present case, a deformation region 10 is provided for each of the outwardly offset battery cells 4 and a respective stabilization region 9 is provided for each of the inwardly offset battery cells 5. Here, the respective stabilization regions 9 and deformation regions 10 are arranged such that respective center axes 11 of the outwardly offset battery cells 4 are outwardly covered by the respective deformation regions 10 on the side 3 on a shortest straight line and respective center axes 11 of the inwardly offset battery cells 5 are outwardly covered by the respective stabilization regions 9 on the side 3 on the shortest straight line. In the present case, it is provided in particular that only the outwardly offset battery cells 4 are outwardly covered by the respective deformation regions 10 on the side 3 and the respective inwardly offset battery cells 5 are outwardly covered by the stabilization regions 9 at least substantially on the side 3 of the battery pack 1. The deformation foam is thus arranged without coverage in relation to respective shortest straight lines from the center axes 11 of the respective inwardly offset battery cells 5 toward the side 3 of the battery pack 1. In the present case, the stabilization regions 9 are additionally arranged without coverage in relation to the respective shortest straight lines from the respective center axis 11 of the respective outwardly offset battery cells 4 toward the side 3 of the battery pack 1.

The structural foam 6 has a first stiffness and the deformation foam has a second stiffness lower than the first stiffness. The stabilization regions 9 have a higher stiffness than the second stiffness of the deformation foam. In particular, the stabilization regions 9 have the first stiffness if the stabilization regions 9 are made from the structural foam 6.

FIG. 2 shows a section through the battery pack 1 along the sectional line A:A. Here, one of the outwardly offset battery cells 4 and the associated deformation region 10 are illustrated in section. The deformation foam has regions of different stiffnesses over the height 12 extending parallel to a direction of longitudinal extent of the center axis 11 in the deformation region 10 shown in FIG. 2. Here, the different stiffnesses are visualized by a respective width of the deformation region 10 in FIG. 2. The narrower the deformation region 10 at the respective height is, the higher the stiffness of the deformation region 10 at this height is. The deformation region 10 shown in FIG. 2 thus has the lowest stiffness in the center and the highest stiffnesses at the very top and very bottom. The deformation region 10 can thus be compressed to the greatest extent halfway up, as a result of which a force introduced into the battery pack 1 on the side 3 is transferred to the outwardly offset battery cell 4 via the deformation region 10 to the least extent at this height. Consequently, a region, arranged at this height, of the outwardly offset battery cell 4 is protected particularly well against the action of force and consequently against damage. This region is thus particularly suitable for the arrangement of sensitive components of this battery cell 4.

FIG. 3 illustrates the battery pack 1 along the sectional line B:B. Here, one of the rearwardly offset battery cells 5 and the associated stabilization region 9 are shown in section. As can be seen in FIG. 3, the stabilization region 9 can have different stiffnesses at different heights, with the stiffnesses at the respective different heights being selected on the basis of a structure of the associated, rearwardly offset battery cell 5. Similarly, to the illustration shown in FIG. 2, the different stiffnesses of the stabilization region 9 in FIG. 3 are visualized by the respective illustrated width of the stabilization region 9 at the respective height 12. The wider the arrangement of the stabilization region 9 at the respective height is, the lower the stiffness of the stabilization region 9 at this height is. Therefore, in the present case, it is also intended for the stabilization region 9 to have the lowest stiffness halfway up and the greatest stiffness at the very top and the very bottom. This makes it possible to protect a central region of the rearwardly offset battery cell 5 that faces the stabilization region 9 against the action of force and consequently against damage particularly well. This region is thus particularly suitable for the arrangement of sensitive components of this battery cell 5.

It may be provided for all the regions of the stabilization region 9 over its height to be formed with a greater stiffness than all the regions of the deformation region 10. As an alternative, it is possible to provide that the deformation region 10 has a lower stiffness than the respective stabilization region 9 only for respective identical heights. It is thus possible to provide that the deformation region 10 has a greater stiffness in a region along the height 12 than the stabilization region 9 does at a different height.

FIG. 4 shows a diagram of a detail of a traction battery for a motor vehicle having the battery pack 1. Here, it is additionally possible to see a housing attachment 13 of the battery pack 1 for attachment to a battery housing 14 of the traction battery. In the arrangement shown in FIG. 4, the housing attachment 13 is inwardly covered by a deformation region 10 on the side 3. If, therefore, the action of force 15 shown in FIG. 4 takes place on the battery pack 1, the deformation region 10 can be used to avoid or at least limit damage to the outwardly offset outermost battery cell 4 by the housing attachment 13 as a result of intrusion and owing to block formation particularly well. The effect of the heterogenous foam insert 8 is a selectively heterogenous intrusion front and relief of the loading of the outwardly offset outermost battery cells 4. It is furthermore possible to achieve reduced block formation on a cell outer side of the outermost, outwardly offset battery cells 4 and a free bead region 16 in the region of the housing attachment 13. The free bead region 16 makes it possible to be able to prevent block formation at this upper edge of the battery pack 1 particularly well in that the bead 17 can be moved toward the outwardly offset outermost battery cell 4 with compression of the deformation region 10. The deformation of the deformation region 10 prevents direct force transfer from the bead 17 to the outwardly offset battery cell 4.

As can be seen in FIG. 4, to fasten and arrange and also fix the respective deformation regions 10 in the foam insert 8, the respective deformation regions 10 can be encapsulated by the structural foam 6 or integrally molded, or foamed, in a pocket kept free in the structural foam 6. A homogenous stiffness of the foam insert 8 could lead to a homogenous intrusion front and consequently to intrusion into at least one outwardly offset battery cell 4.

A cell cluster of the multiplicity of battery cells 2 as a whole is embedded in the structural foam 6, which has a particularly high stiffness and density, as a result of which the battery block is produced. The foam insert 8 is arranged in the outer region of the battery pack 1, in the present case on the side 3. The foam insert 8 has an optimum configuration from a functional perspective in terms of a side-on crash, in particular primarily in terms of a pole crash, as a result of which the loads occurring in the event of an accident can be selectively distributed depending on the cell pattern or a cell arrangement of the battery cells 2 and thus intrusions into respective battery cells 2 can be reduced. As a result, it is possible to obtain primarily increased vehicle safety in real accident situations with increased robustness with respect to thermal events, in addition to cost potentials and weight potentials in terms of development. In the case of upright round cells, it is possible to utilize the fact that there are internal and external battery cells 2 in terms of outermost battery cells 2 in the battery pack 1. The heterogenous foam layer 8 relieves the loads that occur in a side-on crash on the battery cells 2, in particular on the rearwardly offset battery cells 5 and on the forwardly offset battery cells 4, the forwardly offset battery cells being of primary concern, using selectively hard and soft matched regions, in the present case the stabilization regions 9 and the deformation regions 10.

Overall, the invention shows how a heterogenous deformation foam, in the present case the foam insert 8 comprising the deformation foam, adapted to the cell pattern and cell position of respective battery cells 2 can be utilized to reduce the cell intrusion.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Battery pack
2 Battery cell
3 Side
4 Forwardly offset battery cell
5 Rearwardly offset battery cell
6 Structural foam
7 Battery block
8 Foam insert
9 Stabilization region
10 Deformation region
11 Center axis
12 Height
13 Housing attachment
14 Battery housing
15 Action of force
16 Bead region
17 Bead

What is claimed is:

1. A battery pack for a traction battery of a motor vehicle, comprising:
a multiplicity of battery cells embedded in a foam body having regions of different stiffnesses, wherein the foam body comprises a main body made of a structural foam of a first stiffness and a deformation foam with a second stiffness lower than the first stiffness,
wherein the deformation foam, on a side of the battery pack on which outermost battery cells are offset outwardly or inwardly relative to one another, outwardly covers respective outwardly offset battery cells on a shortest straight line from a center axis of the respective battery cells toward the side of the battery pack, and
wherein the deformation foam is arranged without coverage in relation to respective shortest straight lines from a center axis of the respective inwardly offset battery cells toward the side of the battery pack.

2. The battery pack according to claim 1, wherein the deformation foam has different stiffnesses, which are selected on the basis of a structure of the outwardly offset battery cells, over its height extending parallel to a course of the respective center axes of the battery cells.

3. The battery pack according to claim 1, wherein the structural foam has different stiffnesses, which are selected on the basis of a structure of the battery cells, over its height extending parallel to a course of the respective center axes of the battery cells.

4. The battery pack according to claim 1, wherein the battery cells are in the form of round cells and their respective cross sections form a single hexagonal packing of circles in the battery pack.

5. The battery pack according to claim 1, wherein all the battery cells are completely surrounded by the structural foam.

6. The battery pack according to claim 1, wherein the deformation foam is a polyurethane foam.

7. The battery pack according to claim 1, further comprising:
a foam insert comprising the deformation foam for the respective outwardly offset battery cells and respective stabilization regions between adjoining deformation foam for the inwardly offset battery cells,
wherein all the battery cells are outwardly covered by the foam insert on the side of the battery pack, and
wherein the stabilization regions having a higher stiffness than the second stiffness of the deformation foam.

8. The battery pack according to claim 7, wherein the stabilization regions are made from the structural foam.

9. A traction battery for a motor vehicle, having at least one battery pack according to claim 1.

10. The traction battery according to claim 9, wherein a housing attachment of the battery pack is inwardly covered by the deformation foam.
